(19) United States
(12) Patent Application Publication
(10) Pub. No.: US 2012/0166812 A1
(43) Pub. Date: Jun. 28, 2012

(54) METHOD, APPARATUS AND SYSTEM FOR SECURE COMMUNICATION OF RADIO FRONT END TEST/CALIBRATION INSTRUCTIONS

(76) Inventors: Men Long, Beaverton, OR (US); Marian K. Verhelst, Beaverton, OR (US)

(21) Appl. No.: 12/976,946

(22) Filed: Dec. 22, 2010

(51) Int. Cl. G06F 21/00

(52) U.S. Cl. 713/189; 726/26

(57) ABSTRACT

Techniques for a programmable engine to provide security mechanisms protecting information which is in support of testing and/or calibration a radio front end. In an embodiment, test/calibration information is to be communicated to, from or within the programmable engine for processing by a particular resource of the programmable engine. In another embodiment, test/calibration is exchanged along a dedicated hardware data path between a security module of the programmable engine and an execution module of the programmable engine, wherein any data exchanged in the dedicated hardware data path is only accessible from the dedicated hardware data path via one or both of the security module and the execution module.

### BACKGROUND

1. Technical Field

Embodiments relate generally to testing and/or calibration of a radio front end of a communication device. More particularly, various embodiments provide techniques for securely exchanging and/or processing instructions in support of testing and/or calibrating such a radio front end.

2. Background Art

Radio devices having a radio-frequency analog front end (RFE) undergo extensive calibrations and tests in the manufacturing environment after production—e.g. by utilizing a radio-frequency (RF) tester to check whether performance of the device is within specification and/or to retune certain components. However, testing time inevitably will increase in the future as radio devices evolve towards smaller technologies having more variations and/or more complex radios, for example radio devices implementing multiple-input, multiple-output (MIMO), multiband radios, and so on.

After some time in the field, a fraction of deployed RFE chips may fail or start to fail. Since self-testing has been almost nonexistent for radios, chips have previously been unable to be diagnosed remotely, and devices have had to be shipped back to the original equipment manufacturer (OEM). Since the OEM typically may not have the expensive test equipment and expertise to do analog and radio-frequency (RF) tests, the more efficient—but nevertheless somewhat wasteful—option for the OEM has been to simply replace such chips.

Since there is an emerging trend to more closely integrate the analog radio and the digital baseband processor—e.g. on the same chip—and/or to integrate the radio on a main processor die, there are potentially severe implications for the certification of the radios because recertification will be required every time something is altered in the overall chip design, even when the change has little to do with the radio itself

Technologies are only now being introduced to test RFE chip devices remotely—e.g. by exchanging test and/or calibration information between an RFE chip device and a testing (and/or calibration) authority which is remote from the RFE chip device. Such testing/calibration information might be useful for malicious agents (e.g. hackers, malware, etc.) to initiate various security attacks on such RFE chip devices—potentially on a large scale. Therefore, the introduction of remote RFE chip testing and/or calibration has given rise to a need for security measures in support thereof.

### BRIEF DESCRIPTION OF THE DRAWINGS

The various embodiments of the present invention are illustrated by way of example, and not by way of limitation, in the figures of the accompanying drawings and in which:

FIG. 1 is a block diagram illustrating select elements of system for securely exchanging and/or processing test and/or calibration information according to an embodiment.

FIG. 2A is a block diagram illustrating select elements of a radio front end to be tested and/or calibrated based on communications exchanged according to an embodiment.

FIG. 2B is a block diagram illustrating select elements of a radio front end to be tested and/or calibrated based on communications exchanged according to an embodiment.

FIG. 3 is a block diagram illustrating select elements of a programmable engine to exchange testing/calibration communications according to an embodiment.

FIG. 4 is a flow diagram illustrating select elements of a method for exchanging and/or processing testing/calibration communications according to an embodiment.

FIG. 5 is a block diagram illustrating select elements of a computer platform to exchange testing/calibration communications according to an embodiment.

### DETAILED DESCRIPTION

Various embodiments provide techniques for securely exchanging and/or processing information in support of the testing and/or calibration (hereinafter “test/calibration”) of a radio-frequency analog front end (hereinafter “radio front end” or “RFE”) of a computer platform or other information handling system.

By way of illustration and not limitation, exchanging test/calibration information may include exchanging instructions describing a test to be implemented for performance evaluation of an RFE. Alternatively or in addition, exchanging test/calibration information may include exchanging a result of such a test. Alternatively or in addition, exchanging test/calibration information may include exchanging information describing a calibration operation to be performed on the RFE. Alternatively or in addition, exchanging test/calibration information may include providing such communications between a computer platform which includes the RFE and a remote test/calibration authority which provides test instructions and/or collects test results. Alternatively or in addition, exchanging test/calibration information may include exchanging test control signals, test data signals, test results, test reports, calibration information and/or the like between different elements (e.g. ICs, devices, circuit blocks, etc.) within the computer platform which includes the RFE. Processing test/calibration information may include performing calculations, translations, evaluations or other operations within a circuit block or other such functional component of a programmable engine.

In an embodiment, an RFE which is the subject of test/calibration operations may be capable of providing analog transmission and/or reception functionality for signal exchanges on behalf of a digital domain. As used herein, digital domain refers to a group of computer platform elements (e.g. ICs, devices, circuit blocks, etc.) which communicate among one another with digital data signals and/or digital control signals.

A programmable engine including a microcontroller or other processing-capable circuitry may be able to couple to the RFE, where the programmable engine is also capable of being programmed to perform one or more test/calibration operations on the RFE. In an embodiment, the programmable engine may include or otherwise have access to one or more security mechanisms to protect an exchanging and/or processing of information which is in support of such test/calibration operations. By way of illustration and not limitation, the programmable engine may include an execution module and a security module to perform, respectively, an execution of test/calibration instructions and a security processing of information in support of such executing. In an embodiment, the programmable engine may include an isolated hardware data path between the execution module and the security module to protect an exchange of test/calibration information between the execution module and the security module.

Additionally or alternatively, the programmable engine may be able to selectively enable and/or disable one or more interfaces to variously isolate one or more sets of resources of a device—e.g. an integrated circuit (IC) or a computer platform—which includes the RFE and the digital domain. In an embodiment, a selective enabling or disabling one or more interfaces by the programmable engine may be for the purpose of at least partially isolating particular resources—e.g. isolating from some second platform resource but not necessarily from some third platform resource—during a given exchange of test/calibration information. Alternatively or in addition, a selective enabling or disabling one or more interfaces by the programmable engine may be for the purpose of isolating particular resources when test/calibration information is being stored, executed and/or otherwise processed at a particular resource of the computer platform.

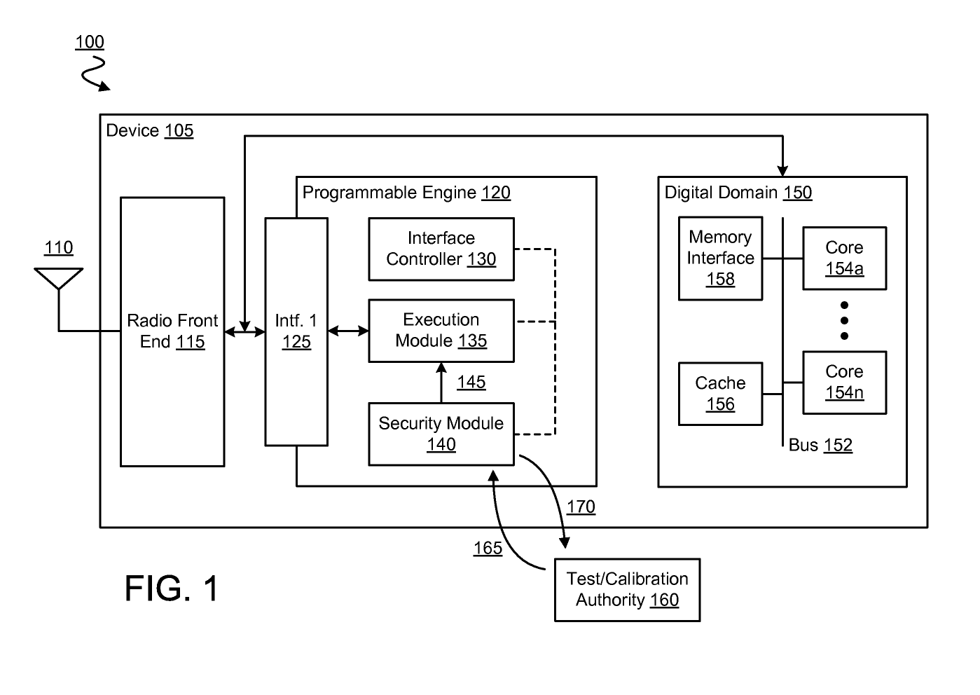

FIG. 1 illustrates select elements of a system 100 for securely exchanging and/or processing test/calibration information according to an embodiment. System 100 may include a device 105 having a RFE 115 which is subject to one or more test/calibration operations. Device 105 may include some or all of the circuitry of a computer platform, for example. By way of illustration and not limitation, device 105 may, in one embodiment, represent one or more integrated circuits (IC)—e.g. including a system-on-chip—residing in a single IC package which is capable of inclusion in a chipset of a computer platform. In an alternate embodiment, device 105 may represent an entire computer platform—e.g. wherein different components of device 105 variously reside on different IC chips, different printed circuit boards, and/or the like.

RFE 115 may provide to the rest of device 105 access to one or more analog transmission and/or analog reception functionalities—e.g. to implement analog signal exchanges via one or more antennae 110 on behalf of a digital domain 150 of device 105. Digital domain 150 may include, according to various embodiments, any of a variety of circuit elements, circuit blocks, ICs, etc. which communicate among one another using digital data signals and/or digital control signals.

By way of illustration and not limitation, digital domain 150 is shown including a bus 152 which couples to one another various components including, for example, one or more processors 154a, . . . , 154n, a memory interface 158 and a cache 156. It is understood that the particular details of digital domain 150 are merely illustrative, and that digital domain 150 may include any of a variety of additional or alternative component digital circuitry one whose behalf RFE 115 provides analog signal transmission/reception functionality. More particularly, the particular digital elements within digital domain 150, and/or their configuration with respect to one another, is not limiting on certain embodiments.

Device 105 may include a programmable engine 120 including logic—e.g. hardware and/or executing software—to perform test/calibration operations for RFE 115. Programmable engine 120 may include or otherwise have access to a first interface 125 capable of coupling programmable engine to RFE 115. RFE 115 may exchange communications with digital domain 150 through programmable engine 120 or, alternatively, through a signal path which is independent of programmable engine 120. In an embodiment, programmable engine 120 may include an execution module 135 having microcontroller or other processing-capable circuitry to execute instruction for configuring RFE 115 for a test, instruction for sending a test pattern through RFE 115, instruction for capturing and/or analyzing an output signal from RFE 115 based on the test pattern, instruction for preparing a test report to be sent from device 105, instructions for performing a calibration of RFE 115, and/or the like.

Programmable engine 120 may further include logic to securely exchange and/or process information in support of test/calibration operations for RFE 115. By way of illustration and not limitation, programmable engine 120 may include a security module 140 including logic to provide security processing of communications exchanged between device 105 and a remote entity such as a remote test/calibration authority 160 which may be accessible, for example, via one or more networks (not shown).

Security module 140 may implement of otherwise provide one or more security functionalities including, but not limited to, functionality to authenticate a test/calibration program, a test/calibration result, a test/calibration authority, an RFE, and the like.

Alternatively or in addition, security module 140 may implement of otherwise provide one or more cryptographic functionalities—e.g. to decrypt test/calibration information which is received by device 105 and/or to encrypt test/calibration information which is to be sent from device 105. It is understood that security module 140 may provide any of a variety of other security processing functionalities, according to different embodiments. Security processing operations of security module 140 may be supported by a data path 145 of device 105 though which security module 140 and execution module 135 exchange test/calibration information. In an embodiment, data path 145 is an isolated hardware path, wherein any data exchanged in the data path 145 is only accessible from the data path 145 via one or both of security module 140 and execution module 135.

In an embodiment, test/calibration authority 160 may provide test/calibration input 165 to device 105. Test/calibration input 165 may, for example, include test control information to be used in configuring circuitry of RFE 115 for a particular test. Alternatively or in addition, test/calibration input 165 may include test pattern information for use in determining a set of signals to send through circuitry of RFE 115—e.g. for later capture and/or evaluation of a response to such a set of signals by RFE 115. Alternatively or in addition, test/calibration input 165 may include calibration information which programmable engine 120 may use to calibrate RFE 115.

Additionally or alternatively, test/calibration authority 160 may receive test/calibration output 170 from device 105. Test/calibration output 170 may, for example, include test result information describing a result of a test which programmable engine 120 performs on RFE 115. Alternatively or in addition, test/calibration output 170 may include information describing a current configuration of RFE 115. It is understood that test/calibration input 165 and/or test/calibration output 170 may additionally or alternatively include any of a variety of combinations of handshaking, cryptographic key exchange communications, authentication factor exchange communications or other types of communications which are in support of an exchange of the types of test/calibration information discussed above.

Programmable engine 120 may further comprise an interface controller 130 including hardware and/or executing software logic to selectively enable or disable one or more interfaces of device 105—e.g. first interface 125 and/or any of various other interfaces through which programmable engine 120 may communicate. As discussed herein, the selective enabling or disabling of interfaces by interface controller 130 may, for example, be performed for the purpose of isolating one or more resources of device 105 during a particular state of communication, storing and/or processing of test/calibration information. Isolation of resources of device 105 may prevent hackers, malware or other malicious agents from gaining access to device 105 to detect or alter test/calibration information. It is understood that such interface control is not limiting on certain embodiments which, for example, provide an isolated hardware path such as data path 145 without also providing functionality such as that of interface controller 130.

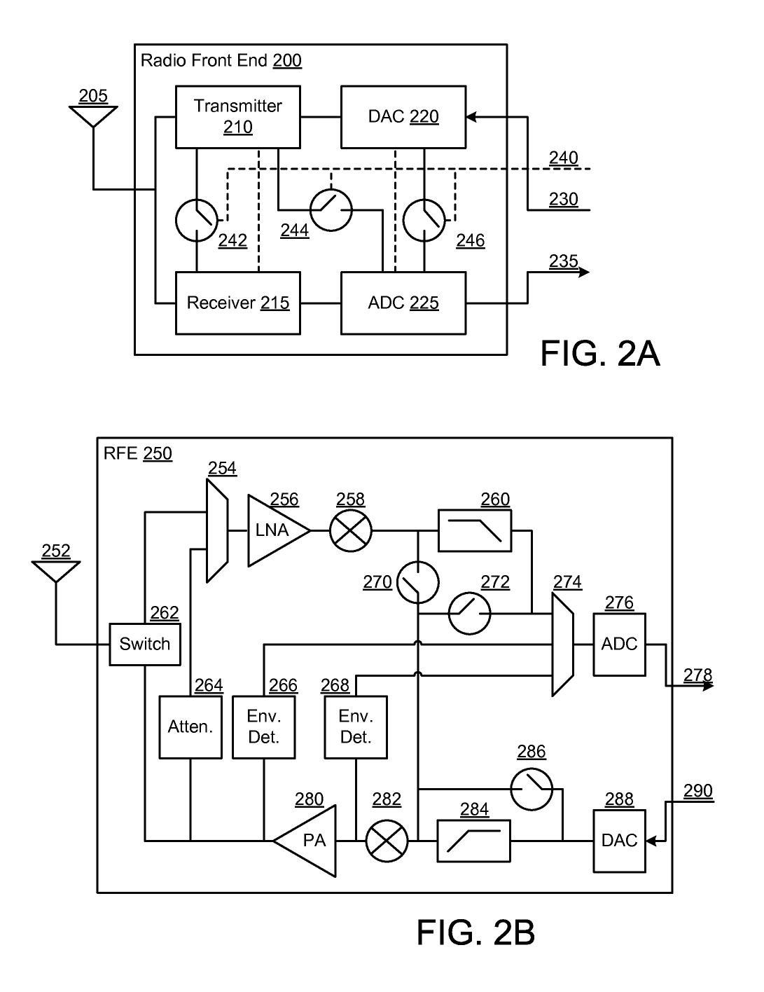

Turning now to FIG. 2A, a high-level view of select elements of a radio front end 200 according to some embodiments is shown. RFE 200 may share some or all of the characteristics which are associated with RFE 115, for example.

RFE 200 may include or connect to one or more antennae 205 to variously transmit or receive radio frequency analog signals—e.g. on behalf of a digital domain of a larger platform (not shown) in which RFE 200 resides. A transmit path of RFE 200 may include a digital-to-analog converter 220 to receive input digital signals 230 which are provided to RFE 200—e.g. via a digital domain and/or a programmable engine—and to generate converted analog signals based on input digital signals 230. The transmit path of RFE 200 may further include a transmitter 210 to receive the converted analog signals from DAC 220 for transmission from RFE 200 via the one or more antennae 205.

Additionally or alternatively, a receive path of RFE 200 may include a receiver 215 to receive analog signals provided to RFE 200 via the one or more antennae 205. The receive path of RFE 200 may further include an analog-to-digital converter (ADC) 225 to convert such analog signals from receiver 215 into output digital signals 235. The output digital signals 235 may then be provided from RFE 200 to a digital domain and/or to a programmable engine (not shown) of the larger computer platform.

In an embodiment, a programmable engine may provide—e.g. via one or more control channels 240—test control information to configure RFE 200 for a test operation. For example, test control information may be variously provided to one or more of transmitter 210, DAC 220, receiver 215 and ADC 225—e.g. to selectively adjust various parameters defining their respective operation. Alternatively or in addition, test control information may be provided to circuitry—e.g. various combinations of one or more switches 242, 244, 246—to selectively bypass one or more components of RFE 200. By selective adjusting and/or bypassing of components of RFE 200, test control information may prepare for a test operation which focuses on particular aspects of RFE 200 performance—e.g. to the exclusion of one or more other aspects of such performance.

After RFE 200 is properly configured by test control information, a test pattern may be provided to RFE 200 e.g. through an input signal line used for the input digital signals 230. The test pattern may be processed by RFE 200 according to its test configuration, resulting in a test output being returned—e.g. via an output signal line used for the output digital signals 235. Based on an evaluation of the test output, it may be determined—e.g. by the programmable engine and/or a remote test/calibration authority—whether and/or how RFE 200 is to be (re)calibrated. Thereafter, RFE 200 may receive—e.g. via the one or more control channels 240—calibration information to set or change one or more performance parameters for calibration of one or more circuit elements in RFE 200.

FIG. 2B is a lower-level view illustrating select elements of an RFE 250 capable of being tested, calibrated and/or controlled by a programmable engine in accordance with one or more embodiments will be discussed. RFE 250 may include some or all of the features of RFE 115 and/or RFE 200, for example. As an example, RFE 250 may couple to programmable engine 120.

RFE 250 may include a switch 262 to selectively switch one or more antennas 252 between transmit and receive paths of RFE 250. A receive path of RFE 250 may include a low noise amplifier 256, mixer 258, and filter 260. An analog-to-digital converter (ADC) 276 converts a received signal 278 into a digital format for processing by a digital domain such as digital domain 150 and/or a programmable engine such as programmable engine 120. Similarly, the transmit path of RFE 250 may include a digital-to-analog converter (DAC) 288 to receive a digital baseband signal 290—e.g. from digital domain 150 and/or programmable engine 120 and convert the signal to an analog signal to be transmitted. The transmit path may further comprise a transmit filter 284, mixer 282, and power amplifier (PA) 280. In one or more embodiments, RFE 250 may include an attenuator 264 coupled to the transmit path and further to the receive path via multiplexer 254.

A first envelope detector 266 may be coupled to transmit path at the output of PA 280 and further to ADC 276 via multiplexer 274. Optionally, a second envelope detector 268 may be coupled to an input of PA 280 and further coupled to ADC 276 via multiplexer 274. In some embodiments, additional loopbacks may be utilized, such as between transmission (Tx) filter 284 output and the receive (Rx) filter 260 input, between the transmission filter 284 input and the receive filter 260 output, between the transmission filter 284 input and output, and/or between the receiver filter 260 input to output, controlled via switches 286, 270, and 272, among several examples. Such an arrangement of RFE 250 may provide bypasses and/or loopback paths to increase the observability of internal nodes of RFE 250 by a programmable engine—e.g. by selecting desired nodes and/or a desired signal level via multiplexer 254 and/or multiplexer 274. Envelope detector 266 and envelope detector 268 allow monitoring the signal at the PA 280 at both its input and its output. A programmable engine may also be capable of selecting operational settings of RFE 250, for example bias currents, filter bandwidths, and so on, for testing and calibration. Adding extra observability circuitry to RFE 250 to calibrate and/or test this front-end may further involve calibration and tests for these circuits, for example envelope detector 266 and/or envelope detector 268 may be calibrated with a reference voltage from a packaged precision resistor, although the scope of the claimed subject matter is not limited in these respects.

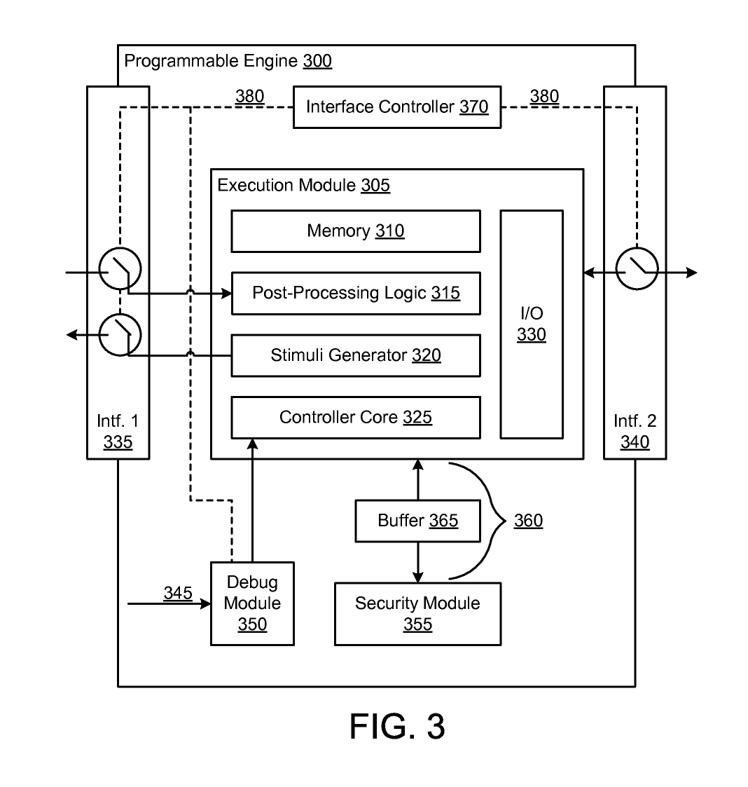

FIG. 3 illustrates select elements of a programmable engine 300 for securely exchanging and/or process test/calibration information according to an embodiment. Programmable engine may have some or all of the characteristics associated with programmable engine 120, for example.

In an embodiment, programmable engine 300 includes or otherwise has access to one or more interfaces through which programmable engine 300 may communicate with one or more resources of a larger computer platform (not shown) in which programmable engine 300 operates. By way of illustration and not limitation, programmable engine 300 may include or otherwise have access to one or more of a first interface 335 which is to couple the programmable engine 300 to an RFE (not shown), a second interface 340 which is to couple the programmable engine 300 to a digital domain (not shown) and a debug module 350 including circuitry to operate as an interface supporting communications according to a debug standard. It is understood that programmable interface may include or otherwise have access to any of a variety of combinations of one or more additional or alternative interfaces for exchange test/calibration information.

In an embodiment, debug module 350 may support communications according to the Joint Test Action Group (JTAG) standard, also known as the Institute of Electrical and Electronics Engineers (IEEE) 1149.1 Standard, released 1990. Debug module 350 may be coupled to a debug port (not shown) by which programmable engine 300 exchanges test/calibration information with a remote authority. In an embodiment, the debug port may be dedicated JTAG pin or other similar interface hardware—e.g. wherein communications by programmable engine 300 using such interface hardware are isolated from some digital domain of the computer platform in which programmable engine 300 operates.

In an embodiment, an interface controller 370 of programmable engine 300 includes hardware and/or executing software logic to selectively provide one or more control signals 380 to selectively enable or disable one or more interfaces, or various combinations thereof, at different times. Such selective enabling and/or disabling may, for example, be for the purpose of at least partially isolating one or more resources of the computer platform in which programmable engine 300 operates. By way of illustration and not limitation, interface controller 370 may, at various times, selectively disable one or more of first interface 335, second interface 340 and debug module based on a particular state of communication, storage and/or processing of test/calibration information within the computer platform.

In an embodiment, programmable engine includes an execution module 305 including microcontroller or other processing-capable circuitry to execute instructions in support of test/calibration operations for a RFE (not shown). For example, execution module 305 may include a controller core 325 to execute test/calibration firmware—e.g. provided by a remote authority. Additionally or alternatively, execution module 305 may implement networking, security or other functionalities in support of exchanging and/or executing such test/calibration firmware.

In an embodiment, execution of test/calibration firmware may cause controller core 325 to control signaling for configuration of a RFE to be tested and/or for the actual testing of the RFE—e.g. by sending a test pattern through the RFE. Alternatively or in addition, execution of test/calibration firmware may cause the controller core 325 to control retrieving and/or analysis of a result of RFE testing. Alternatively or in addition, execution of test/calibration firmware may cause the controller core 325 to control calibration of an RFE based on the result of the RFE testing.

By way of illustration and not limitation, controller core 325 may direct stimuli generator logic 320 of execution module 305 to send one or more of test configuration information, test pattern information and calibration information to an RFE—e.g. via first interface 335. Controller core 325 may further direct post-processing logic 315 of execution module 305 to receive and/or analyze one or more signals generated from the tested RFE as a result of the test pattern. In an embodiment, execution module 305 may include a memory 310 to store test/calibration firmware, test result information, and/or a test report to be sent to a remote authority. I/O logic 330 of execution module 305 may support execution module 305 communicating with one or more interfaces to other resources of the computer platform in which programmable engine 300 operates, and or with the remote authority—e.g. via a network.

In an embodiment, test/calibration information 345 is received at programmable engine 300 through debug module 350. Debug module 350 may provide some or all of test/calibration information 345 directly or indirectly to a security module 355 of programmable engine 300. By way of illustration and not limitation, test/calibration information 345 may be first provided to controller core 325, which identifies that the information requires security processing by security module 355. In an embodiment, some or all of the test/calibration information 345 may be provided from execution module 305 to security module 355—e.g. via a path 360. In an embodiment, some or all of path 360 is a dedicated hardware path between security module 355 and execution module 305. For example, some or all of path 360 may be an isolated hardware path, wherein any data being exchanged between security module 355 and execution module 305 is only accessible from path 360 via security module 355 or execution module 305. In an embodiment, data path 360 includes a buffer 365—e.g. a first-in-first-out (FIFO) buffer—to regulate an exchanging of test/calibration of along path 360.

Security module 355 may perform one or more security operations on test/calibration information received at programmable engine 300. By way of illustration and not limitation, security module 355 may store or otherwise have access to one or more authentication factors, wherein security module 355 performs an authentication of the test/calibration information based on such one or more authentication factors. Such authentication may include, for example, security module 355 verifying one or more authentication credentials for a remote authority and/or for a set of test/calibration instructions.

Additionally or alternatively, security module 355 may perform cryptographic processing—e.g. encryption and/or decryption—of test/calibration information for secure communication of such test/calibration information. In certain embodiments—e.g. where security module 355 is integrated on an IC die with other components of programmable engine 300—use of die space may be improved by iterative use circuit components for cryptographic processing. By way of illustration and not limitation, security module 355 may include a substitution box (or S-box) including logic to perform a cryptographic transformation, wherein verifying the cryptographic authenticity of a set of test/calibration information includes the substitution box iteratively performing (1) processing a portion of the test/calibration information to generate an intermediate authentication result, and (2) receiving the intermediate authentication result for further processing. Such iterative cryptographic processing allows reuse of a substitution box or other logic, which in turn allows for tighter integration of a smaller security module 355 with other IC components of programmable engine 300.

In an embodiment, the selective disabling of one or more interfaces by interface controller 370 may be based on a state of communication, storing, processing and/or execution of test/calibration information. By way of illustration and not limitation, interface controller 370 may operate to disable one or more interfaces—e.g. at least second interface 340—so that at a particular time, programmable engine 300 isolated from any malevolent logic potentially operating in a digital domain of the larger computer platform in which programmable engine 300 operates.

Interface controller may have access to, or otherwise operate in response to, state information indicating that test/calibration information is being exchanged along a particular path within programmable engine 300, that test/calibration information is being stored in execution module 305, that test/calibration information is being executed by execution module 305, and/or the like. Hackers, malware, viruses, spyware, or various other malicious agents might seek such circumstances as an opportunity to snoop or otherwise attack programmable engine 300—e.g. in an attempt to acquire information about such test/calibration operations, or to tamper with the results.

The security mechanisms of programmable engine—e.g. the security processing provided by security module 355, the dedicated path 360 from security module 355 to execution module 305, the selective disabling of one or more interfaces by interface controller 370—provide protection for test/calibration communication within programmable engine 300, from programmable engine 300 to other resources in the computer platform, and/or between the computer platform and a remote authority.

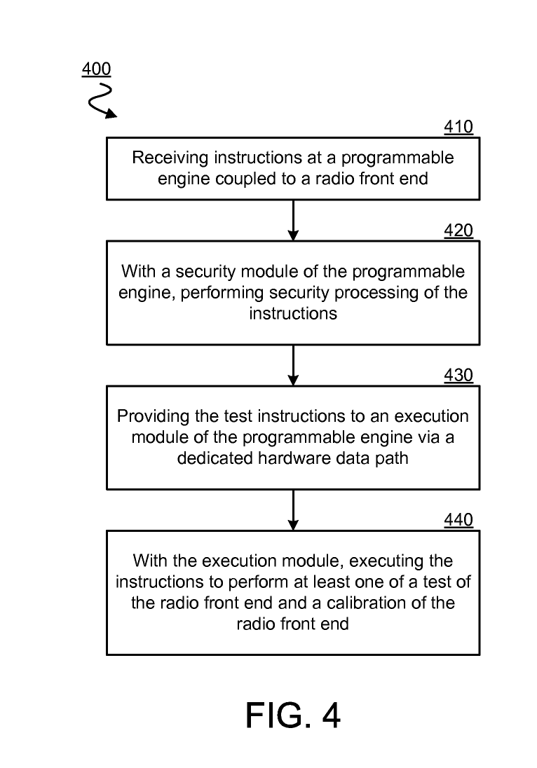

FIG. 4 illustrates select elements of a method 400 for securely exchanging and/or processing test/calibration information according to an embodiment. Method 400 may be performed by programmable engine 300, for example.

In an embodiment, method 400 includes a programmable engine receiving test/calibration instructions, at 410. After receiving such instructions, a security module of the programmable engine may, at 420, perform security processing of the instructions. Such security processing may include, for example, one or more of an authentication of the instructions and a cryptographic processing of the instructions. After the security processing, the test instructions may, at 430, be provided to an execution module of the programmable engine. In an embodiment, the test instructions are exchanged along a dedicated hardware data path between the execution module and the security module—e.g. wherein any data exchanged in the data path is only accessible from that data path via one or both of the security module and the execution module.

The programmable engine may, at 440, execute the instructions received from the security module. In an embodiment, execution of the instructions by the programmable engine may implement at least a testing of radio front end which is coupled to the programmable engine. Alternatively or in addition, such executing of the instructions may implement a calibration of the radio front end.

In an embodiment, interface controller of the programmable engine may be provided to extend techniques of method 400 to include, for example, disabling one or more interfaces of the programmable engine for an isolation of the programmable engine during the exchange, security processing, and/or executing of the instructions. By way of illustration and not limitation, the disabling of the one or more interfaces may isolate the programmable interface from a digital domain with which the RFE is to exchange communications.

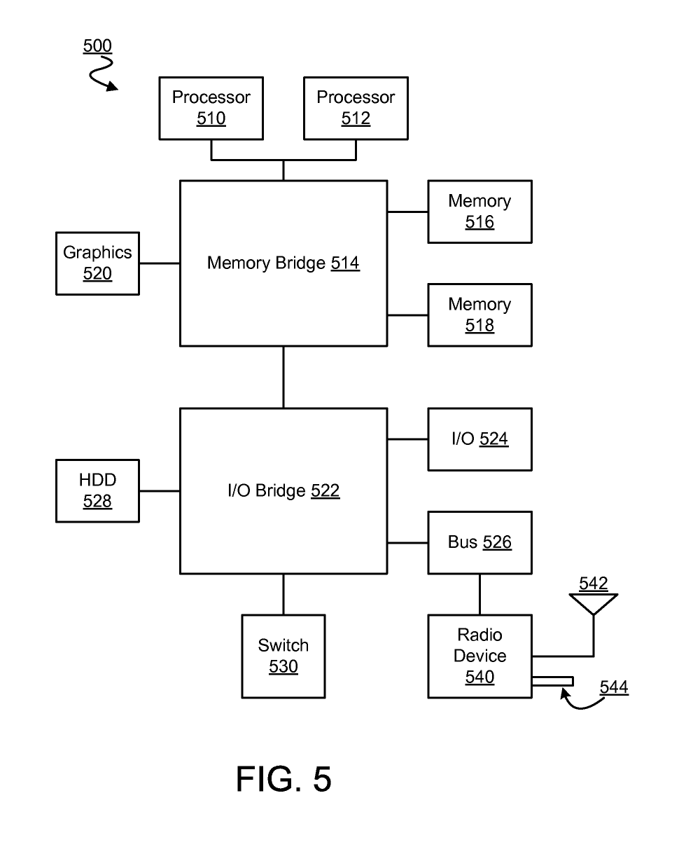

FIG. 5 illustrates select elements of a computer platform 500 for exchanging and/or communicating test/calibration information according to an embodiment. By way of illustration and not limitation, computer platform 500 may include a platform one or more of a desktop personal computer (PC), laptop PC, notebook device, any of a variety of handheld devices (e.g. tablet, smart phone or other cellular device, etc.), and the like.

Computer platform 500 may operate as an information handling system with a radio device having a programmable engine for securely exchanging and/or processing instructions for—and/or results of—a test/calibration operation, in accordance with one or more embodiments. Computer platform 500 may, for example, include a platform on which radio device 100 of FIG. 1 is deployed. Although computer platform 500 represents one example of several types of computing platforms, computer platform 500 may include more or fewer elements and/or different arrangements of elements than shown in FIG. 5, and the scope of the claimed subject matter is not limited in these respects.

Computer platform 500 may comprise one or more processors such as one or more processors 510, . . . , 512, which may comprise one or more processing cores. Some or all of the one or more processors 510, . . . , 512 may couple to one or more memories 516, . . . , 518 via memory bridge 514, which may be disposed external to the one or more processors 510, . . . , 512, or alternatively at least partially disposed within some or all of one or more processors 510, . . . , 512. Memory 516 and/or memory 518 may comprise various types of semiconductor based memory, for example volatile type memory and/or nonvolatile type memory. Memory bridge 514 may couple to a graphics system 520 to drive a display device (not shown) coupled to computer platform 500. Computer platform 500 may further comprise input/output (I/O) bridge 522 to couple to various types of I/O systems. For example, I/O bridge 524 may comprise a universal serial bus (USB) type system, an IEEE 1394 type system, or the like, to couple one or more peripheral devices—e.g. an I/O device 524—to computer platform 500. Bus system 526 may comprise one or more bus systems such as a peripheral component interconnect (PCI) express type bus or the like, to connect one or more peripheral devices to computer platform 500. A hard disk drive (HDD) controller system 528 may couple one or more hard disk drives or the like to information handling system, for example Serial ATA type drives or the like, or alternatively a semiconductor based drive comprising flash memory, phase change, and/or chalcogenide type memory or the like. Switch 530 may be utilized to couple one or more switched devices to I/O bridge 522, for example Gigabit Ethernet type devices or the like. As shown in FIG. 5, computer platform 500 may include radio device 540—e.g. device 100 of FIG. 1.

In an embodiment, radio device 540 may exchange radio communications on behalf of computer platform 500 via one or more antennae 542. Alternatively or in addition, a radio front end (not shown) of radio device may be tested and/or calibrated using communications which are exchanged using radio device 540. By way of illustration and not limitation, radio device 540 may include a debug port 544 to exchange test/calibration information. In an embodiment, some or all communications via debug port 544 may be isolated from a digital domain of computer platform 500 which radio device 540 accesses via bus 526.

Techniques and architectures for securely communicating test and/or calibration information are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A device comprising:
a programmable engine having:
a first interface to couple the programmable engine to a radio front end;
a security module to receive instructions provided to the programmable engine, the security module further to perform a security processing of the instructions; and
an execution module coupled to the security module to receive the instructions after the security processing and to execute the instructions to perform at least one of a test of the radio front end and a calibration of the radio front end, wherein after the security processing, the instructions are communicated along a dedicated data path between the security module and the execution module, wherein any data exchanged along the dedicated data path is accessible only through one or both of the security module and the execution module.

2. The device of claim 1, wherein the security processing includes performing an authentication of the instructions.

3. The device of claim 1, wherein the security processing includes performing a decryption of the instructions.

4. The device of claim 1, wherein the radio front end exchanges communications with a digital domain, the device further comprising a debug interface to receive the instructions for the programmable engine independent of the digital domain.

5. The device of claim 1, further comprising:
an interface controller to disable one or more interfaces of the programmable engine for an isolation of the programmable engine during the executing of the instructions.

6. The device of claim 5, wherein the interface controller to disable the one or more interfaces includes the interface controller to disable a debug interface.

7. The device of claim 5, wherein the interface controller further to disable an interface of the programmable engine for an isolation of the programmable engine during an exchange of the instructions along a data path within the programmable engine.

8. The device of claim 5, wherein the interface controller further to disable an interface of the programmable engine for an isolation of the programmable engine during the security processing of the instructions.

9. The device of claim 1, wherein the cryptographic module includes a substitution box, wherein verifying the cryptographic authenticity of the firmware includes the substitution box iteratively performing:
processing a portion of firmware data to generate an intermediate authentication result; and
further processing the intermediate authentication result.

10. The device of claim 1, wherein the interface control logic further to enable the at least one of the first interface and the second interface in response to an indication that the test of the radio front end has completed.

11. A system comprising:
one or more antennae to coupled the system to a network;
a radio front end coupled to the one or more antennae, the radio front end to exchange communications with a digital domain;
a programmable engine having:
a first interface coupling the programmable engine to the radio front end;
a security module to receive instructions provided to the programmable engine, the security module further to perform a security processing of the instructions;
an execution module coupled to the security module to receive the instructions after the security processing and to execute the instructions to perform at least one of a test of the radio front end and a calibration of the radio front end, wherein after the security processing, the instructions are communicated along a dedicated data path between the security module and the execution module, wherein any data exchanged along the dedicated data path is accessible only through one or both of the security module and the execution module.

12. The system of claim 11, wherein the security processing includes performing at least one or an authentication of the instructions and a decryption of the instructions.

13. The system of claim 11, further comprising:
an interface controller to disable one or more interfaces of the programmable engine for an isolation of the programmable engine during the executing of the instructions

14. The system of claim 11, wherein the interface controller further to disable an interface of the programmable engine for an isolation of the programmable engine during the security processing of the instructions.

15. The system of claim 11, wherein the interface controller further to disable an interface of the programmable engine for an isolation of the programmable engine during an exchange of the instructions along a data path within the programmable engine.

16. A method comprising:
receiving instructions at a programmable engine coupled to a radio front end via a first interface of the programmable engine, wherein the radio front end exchanges communications with a digital domain;
with a security module of the programmable engine, performing a security processing of the instructions;
after the security processing, providing the test instructions to an execution module of the programmable engine, wherein the instructions are communicated along a dedicated data path between the security module and the execution module, wherein any data exchanged along the dedicated data path is accessible only through one or both of the security module and the execution module;
with the execution module, executing the instructions to perform at least one of a test of the radio front end and a calibration of the radio front end.

17. The method of claim 16, wherein the security processing includes performing at least one or an authentication of the instructions and a decryption of the instructions.

18. The method of claim 16, further comprising:
with an interface controller of the programmable engine, disabling one or more interfaces of the programmable engine for an isolation of the programmable engine during the executing of the instructions.

19. The method of claim 16, further comprising the interface controller disabling an interface of the programmable engine for an isolation of the programmable engine during the security processing of the instructions.

20. The method of claim 16, further comprising the interface controller disabling an interface of the programmable engine for an isolation of the programmable engine during an exchange of the instructions along a data path within the programmable engine.
